(19) United States
(12) Patent Application Publication
(10) Pub. No.: US 2023/0060943 A1
(43) Pub. Date: Mar. 2, 2023

(54) MEMORY DEVICE DEFECT MANAGEMENT

(71) Applicant: Micron Technology, Inc., Boise, ID (US)

(72) Inventors: Jun Xu, San Jose, CA (US); Kitae Park, Cupertino, CA (US)

(21) Appl. No.: 17/889,648

(22) Filed: Aug. 17, 2022

Related U.S. Application Data
(60) Provisional application No. 63/239,535, filed on Sep. 1, 2021.

(51) Int. Cl. G06F 3/06

(52) U.S. Cl. CPC G06F 3/0619; G06F 3/0653; G06F 3/0679

(57) ABSTRACT

A system includes a memory device including a memory array and a processing device, operatively coupled with the memory array, to perform operations including causing defect management information to be obtained from the memory device. The defect management information includes status information with respect to a status of the memory array and supplemental defect management information associated with a media access operation performed with respect to the memory array. The operations further include analyzing the defect management information to determine a likelihood of defect with respect to the memory array, and identifying, based on the likelihood of defect, a defect status of the memory array.

### RELATED APPLICATION

This application claims the benefit of U.S. Provisional Application 63/239,535 filed on Sep. 1, 2021 and entitled “MEMORY DEVICE DEFECT MANAGEMENT,” the entire contents of which are incorporated by reference herein.

### TECHNICAL FIELD

Embodiments of the disclosure relate generally to memory sub-systems, and more specifically, relate to memory device defect management in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of a memory device in communication with a memory sub-system controller of a memory sub-system in accordance with some embodiments of the present disclosure.

FIG. 3 is a block diagram of a system to perform memory device defect management in accordance with some embodiments of the present disclosure.

FIG. 4 is a flow diagram of an example method performed by a local media controller to perform defect management, in accordance with some embodiments of the present disclosure.

FIG. 5 is a flow diagram of an example method performed by a memory sub-system controller to perform defect management, in accordance with some embodiments of the present disclosure.

FIG. 6 is a diagram of an example three-dimensional (3D) replacement gate memory device, in accordance with some embodiments of the present disclosure

FIG. 7 is a block diagram of an example computer system in which embodiments of the present disclosure may operate.

### DETAILED DESCRIPTION

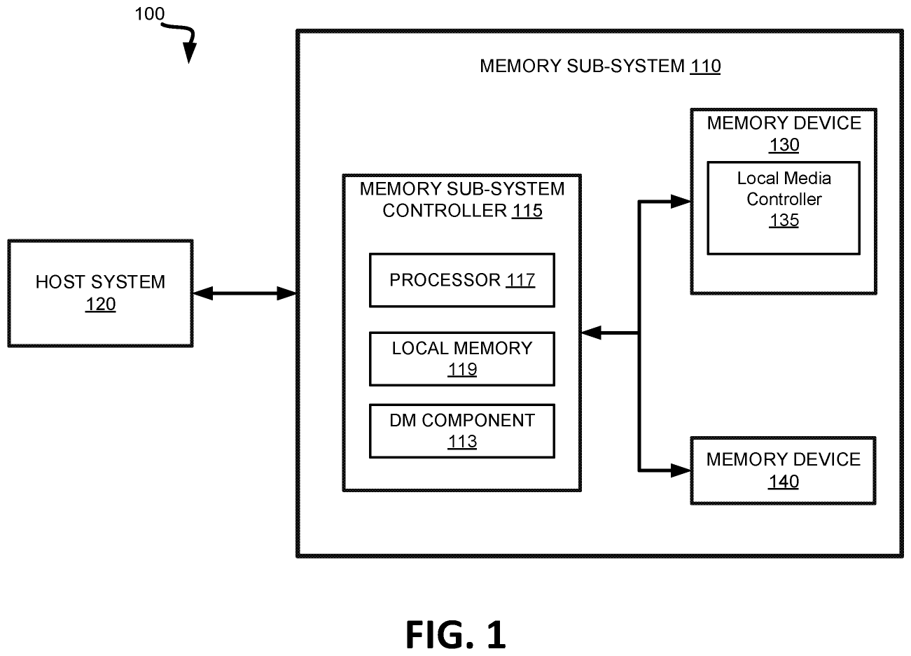

Aspects of the present disclosure are directed to memory device defect management. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells. A memory cell is an electronic circuit that stores information. Depending on the memory cell type, a memory cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or three-dimensional grid. The memory cells are formed onto a silicon wafer in an array of columns (also hereinafter referred to as bitlines) and rows (also hereinafter referred to as wordlines). A wordline can refer to one or more conductive lines of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types. For ease of description, these circuits can be generally referred to as independent plane driver circuits. Control logic on the memory device includes a number of separate processing threads to perform concurrent memory access operations (e.g., read operations, program operations, and erase operations). For example, each processing thread corresponds to a respective one of the memory planes and utilizes the associated independent plane driver circuits to perform the memory access operations on the respective memory plane. As these processing threads operate independently, the power usage and requirements associated with each processing thread also varies.

A three-dimensional (3D) replacement gate memory device (e.g., 3D replacement gate NAND) is a memory device with a replacement gate structure using wordline stacking. For example, a 3D replacement gate memory device can include wordlines, select gates, etc. sandwiched between sets of layers including a pillar (e.g., polysilicon pillar), a tunnel oxide layer, a charge trap (CT) layer, and a dielectric (e.g. oxide) layer. A 3D replacement gate memory device can have a “top deck” corresponding to a first side and a “bottom deck” corresponding to a second side. For example, the first side can be a drain side and the second side can be a source side. Data in a 3D replacement gate memory device can be stored as 1 bit/memory cell (SLC), 2 bits/memory cell (MLC), 3 bits/memory cell (TLC), etc. Read window budget (RWB) margin corresponding to the distance between valleys of a threshold voltage distribution can decrease as the number of bits/memory cell increases.

In certain memory devices, such as 3D replacement gate memory devices (e.g., 3D replacement gate NAND devices), a die can provide its status through at least one register (e.g., 8-bit register). More specifically, the at least one status register can include a status register and an extended status register. Regarding program operation status or erase operation status, the status register can include a bit to indicate whether a program operation or an erase operation has passed or failed. That is, when set to one particular state, the bit can indicate that an error occurred during the program operation or the erase operation. However, for a multi-plane device including a number of planes, the bit may not indicate which plane has failed. To address this, a command (e.g. 78h command) can be sent to each plane to determine which of the planes has failed.

It may be the case that the memory device can include one or more defects. A defect can result in failure during a memory device operation, such as an erase operation, a program operation or a read operation. For example, a local media controller of a memory device of a memory sub-system (e.g., a NAND controller of a NAND memory device) can return a program failure if a programming voltage exceeds a threshold programming voltage, a programming loop exceeds a maximum programming loop, a WL leak current is detected during application of a program pulse (e.g., by using a charge pump clock monitor (CPCM) detection method), a WL leak is detected by a WL read-verify voltage (V_{wlrv}) regulator during program verify (e.g., by using a WL short sensor detection method). As another example, a memory device can return an erase failure if, for example, the number of erase loops performed during the erase operation exceeds a threshold number of erase loops.

However, there can be a possibility of pass/fail misjudgment made by the local media controller. For example, the information used by the local media controller may not be sufficient to make an accurate pass/fail determination. Additionally, a defect, such as a defect in an early stage, can still return as a pass. For example, a leak current during an early stage of a defect may be sufficiently small such that the memory array can still pass a read or program operation, but the defect can be more severe with more usage and/or stress. Moreover, as mentioned above with respect to multi-plane devices, a failed plane can impact non-failed or good planes, and the status indicated by the status register for a program operation or an erase operation may not accurately capture the status of the multi-plane device. The memory sub-system controller of the memory sub-system can lack information as well. For example, the memory sub-system controller can have 1-bit of pass/fail information from each plane.

Aspects of the present disclosure address the above and other deficiencies by implementing memory device defect management in a memory sub-system controller. A memory sub-system can include the memory sub-system controller and the memory device (e.g., NAND memory device). The memory device can include a local media controller, a memory array, a status register maintaining status information indicating a pass/fail status of a memory array of the memory device, and a supplemental defect management information store for maintaining supplemental defect management information that can assist the memory sub-system controller in detecting a defect with respect to the memory array of the memory device. In some embodiments, the supplemental defect management information store includes a volatile memory device. For example, the supplemental defect management information store can include a static random-access memory (SRAM) device.

The supplemental defect management information can include information that can be analyzed to determine a risk of a defect of the memory array. The supplemental defect management information can include information pertaining to a media access operation performed with respect to the memory array. For example, the supplemental defect management information can include information related to a program operation, an erase operation, or a read operation that is performed with respect to the memory array. Examples of information related to a program operation can include dynamic (WL) start program voltage (DSV), number of programming pulses of each threshold voltage level, a check or count fail byte (CFBYTE) of each program verify level, a number of programming loops, information related to detecting a short or leakage during the program operation (e.g., a charge pump clock monitor (CPCM) count of each programming pulse, a WL short sensor reading of each program verify level), etc. Examples of information related to an erase operation can include a number of erase pulses, a CFBYTE of each erase verify level, information related to detecting a short or leakage with respect to a WL or source line during the erase operation (e.g., a CPCM count of each erase pulse, a WL short sensor reading of each erase verify level), etc. Examples of information related to a read operation can include information related to detecting a short or leakage with respect to a WL, WL ramp up time, etc. A CFBYTE threshold is generally decided based on the error correction code (ECC) capability of the memory device, and a CFBYTE number can be determined during each program/erase verify level. If the CFBYTE number for memory cells during a particular program/erase level is below the CFBYTE threshold, these memory cells can be further inhibited from further program/erase in all subsequent program/erase pulses, and the local memory controller can further cease issuing program/erase verify pulses for that particular program/erase verify level in all subsequent program/erase loops.

To implement defect management at the memory sub-system controller, the memory sub-system controller can optionally issue a command to enable defect management, such as a “set feature” command (e.g., EFh command). The local media controller can store supplemental defect management information in the supplemental defect management information store during a media access operation performed with respect to the memory array. Upon completion of the media access operation, instead of obtaining only the 1-bit pass/fail status information from the status register, the memory sub-system controller can also obtain the supplemental defect management information stored in the supplemental memory device by issuing a “get feature” command (e.g., EEh command) or other suitable command. The memory sub-system controller can then analyze the combination of the status information and the supplemental defect management information to determine whether a block should be treated as being a defective or bad block. For example, if the status information indicates “pass” and the analysis of the supplemental defect management information indicates that there is no risk that the block is defective, then the memory sub-system controller can identify the block as passing and no further screen need to be performed. If the status information indicates pass, but the analysis of the supplemental defect management information indicates a low risk that the block is defective, then the memory sub-system can designate the block for further screening (e.g., for stress, short and/or leakage detection). If the status information indicates “fail,” or the status information indicates “pass” and the analysis of the supplemental defect management information indicates a high risk that the block is defective, then the memory sub-system can cause the data of the block to be migrated to another block, and the memory sub-system can identify the block as being a defective or bad block. Accordingly, by offloading defect management to the memory sub-system controller, instead of performing the defect management locally on the memory device, memory device performance can be improved, and memory device die size need not increase.

Advantages of the present disclosure include, but are not limited to, improved memory device defect detection, and improved memory device performance and reliability.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level memory cells (SLC) can store one bit per memory cell. Other types of memory cells, such as multi-level memory cells (MLCs), triple level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

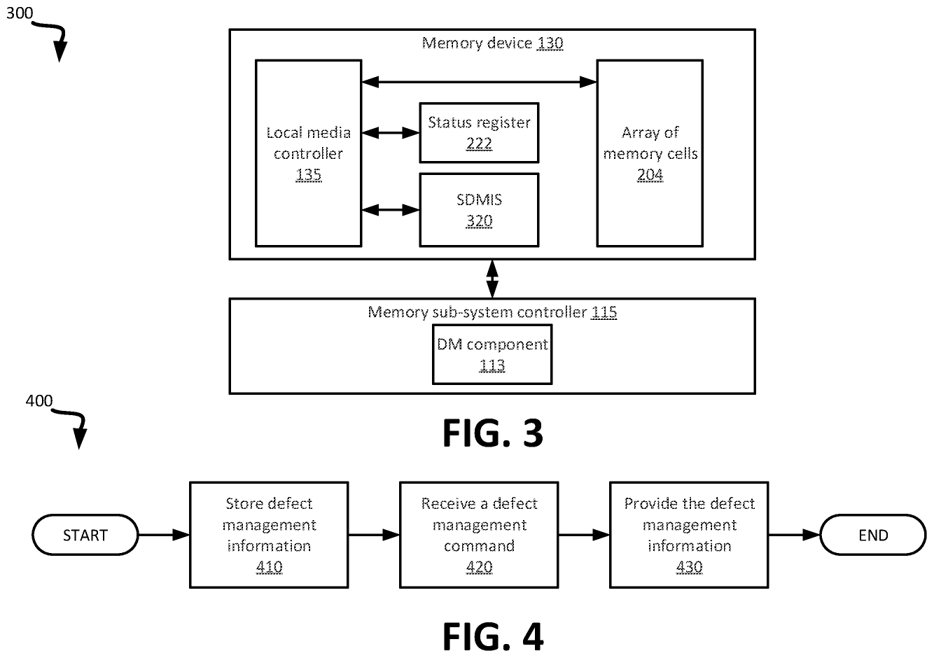

The memory sub-system controller 115 can implement a defect management (DM) component 113 that can perform defect detection and management during media access operation. For example, the DM component 113 can, in conjunction with the local media controller 135, perform defect memory device defect management with respect to the memory device 130. For example, the DM component 113 can cause defect management to be obtained from the memory device 130, analyze the defect management information to determine a likelihood of defect with respect to a memory array of the memory device 130, and identify a defect status of the memory array based on the likelihood of defect. More specifically, the defect management information can include status information with respect to a status of the memory array of the memory device 130, and supplemental defect management information associated with a media access operation performed with respect to the memory array of the memory device 130. The status information can include a bit indicative of the status of the memory array of the memory device 130 as identified by the local media controller 135, and can be maintained on a status register of the memory device 130. The supplemental defect management information can include data related to, e.g., a programming operation, a write operation, or a read operation performed with respect the memory array of the memory device 130, and the supplemental defect management information can be maintained on volatile memory (e.g., static random-access memory (SRAM)) of the memory device 130. Further details regarding the operations of the DM component 113, the status information and the supplemental defect management information will be described below with reference to FIGS. 3-5.

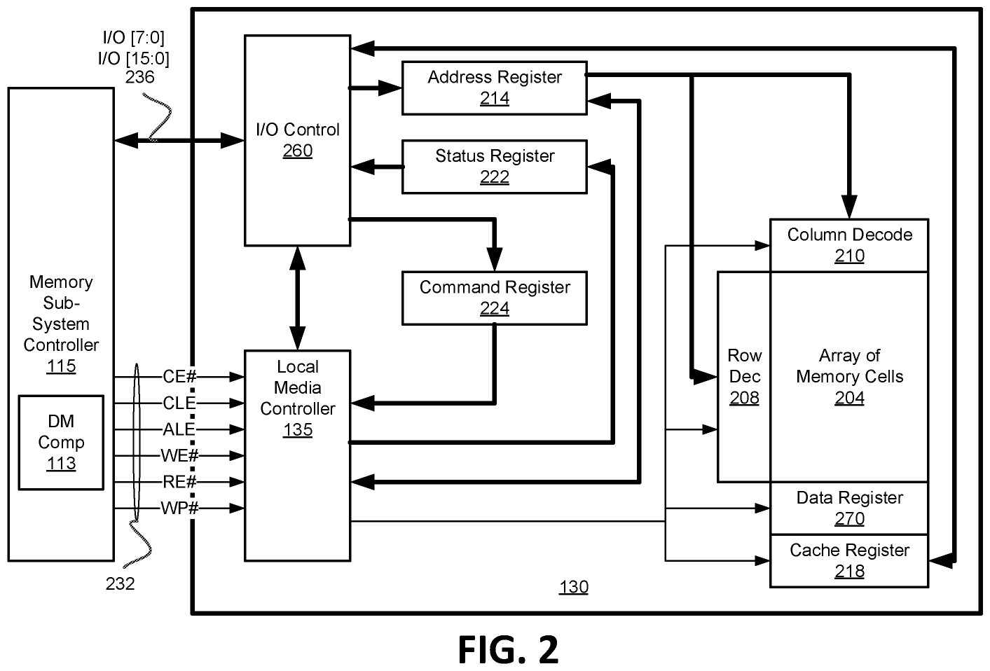

FIG. 2 is a simplified block diagram of a first apparatus, in the form of a memory device 130, in communication with a second apparatus, in the form of a memory sub-system controller 115 of a memory sub-system (e.g., memory sub-system 110 of FIG. 1), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 204 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 2) of at least a portion of array of memory cells 204 are capable of being programmed to one of at least two target data states.

Row decode circuitry 208 and column decode circuitry 210 are provided to decode address signals. Address signals are received and decoded to access the array of memory cells 204. Memory device 130 also includes input/output (I/O) control circuitry 260 to manage input of commands, addresses and data to the memory device 130 as well as output of data and status information from the memory device 130. An address register 214 is in communication with I/O control circuitry 260 and row decode circuitry 208 and column decode circuitry 210 to latch the address signals prior to decoding. A command register 224 is in communication with I/O control circuitry 260 and local media controller 135 to latch incoming commands.

A controller (e.g., the local media controller 135 internal to the memory device 130) controls access to the array of memory cells 204 in response to the commands and generates status information for the external memory sub-system controller 115, i.e., the local media controller 135 is configured to perform access operations (e.g., read operations, programming operations and/or erase operations) on the array of memory cells 204. The local media controller 135 is in communication with row decode circuitry 208 and column decode circuitry 210 to control the row decode circuitry 208 and column decode circuitry 210 in response to the addresses.

The local media controller 135 is also in communication with a cache register 218. Cache register 218 latches data, either incoming or outgoing, as directed by the local media controller 135 to temporarily store data while the array of memory cells 204 is busy writing or reading, respectively, other data. During a program operation (e.g., write operation), data may be passed from the cache register 218 to the data register 270 for transfer to the array of memory cells 204; then new data may be latched in the cache register 218 from the I/O control circuitry 260. During a read operation, data may be passed from the cache register 218 to the I/O control circuitry 260 for output to the memory sub-system controller 115; then new data may be passed from the data register 270 to the cache register 218. The cache register 218 and/or the data register 270 may form (e.g., may form a portion of) a page buffer of the memory device 130. A page buffer may further include sensing devices (not shown in FIG. 2) to sense a data state of a memory cell of the array of memory cells 204, e.g., by sensing a state of a data line connected to that memory cell. A status register 222 may be in communication with I/O control circuitry 260 and the local memory controller 135 to latch the status information for output to the memory sub-system controller 115. In one embodiment, memory sub-system controller 115 includes the DM component 113, which can perform defect management using the status information received form the memory device 130.

Memory device 130 receives control signals at the memory sub-system controller 115 from the local media controller 135 over a control link 232. For example, the control signals can include a chip enable signal CE#, a command latch enable signal CLE, an address latch enable signal ALE, a write enable signal WE#, a read enable signal RE#, and a write protect signal WP#. Additional or alternative control signals (not shown) may be further received over control link 232 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 236 and outputs data to the memory sub-system controller 115 over I/O bus 236.

For example, the commands may be received over input/output (I/O) pins [7:0] of I/O bus 236 at I/O control circuitry 260 and may then be written into command register 224. The addresses may be received over input/output (I/O) pins [7:0] of I/O bus 236 at I/O control circuitry 260 and may then be written into address register 214. The data may be received over input/output (I/O) pins [7:0] for an 8-bit device or input/output (I/O) pins [15:0] for a 16-bit device at I/O control circuitry 260 and then may be written into cache register 218. The data may be subsequently written into data register 270 for programming the array of memory cells 204.

In an embodiment, cache register 218 may be omitted, and the data may be written directly into data register 270. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 2 has been simplified. It should be recognized that the functionality of the various block components described with reference to FIG. 2 may not necessarily be segregated to distinct components or component portions of an integrated circuit device. For example, a single component or component portion of an integrated circuit device could be adapted to perform the functionality of more than one block component of FIG. 2. Alternatively, one or more components or component portions of an integrated circuit device could be combined to perform the functionality of a single block component of FIG. 2. Additionally, while specific I/O pins are described in accordance with popular conventions for receipt and output of the various signals, it is noted that other combinations or numbers of I/O pins (or other I/O node structures) may be used in the various embodiments.

FIG. 3 is a block diagram of a system 300 to perform memory device defect management, in accordance with some embodiments of the present disclosure. As shown, the system 300 includes the memory sub-system controller 115 and the memory device 130 described above with reference to FIGS. 1 and 2. For example, the memory sub-system controller 115 can include the DM component 113 described above with reference to FIGS. 1 and 2. The memory device 130 can include the local media controller 135, the status register 222, and the array of memory cells (“memory array”) 204. In addition, the memory device 130 can further include a supplemental defect management information store (SDMIS) 320.

The memory sub-system controller 115, through the DM component 113, can communicate with the memory device 130 to perform defect management. For example, the memory sub-system controller 115 can (optionally) enable defect management. More specifically, the memory sub-system controller 115 can issue a command to the memory device 130 to enable defect management, such as a “set feature” command (e.g., EFh command). The local media controller 115 can then perform memory array operations, and store supplemental defect management information in the SDMIS 320 obtained during a media access operation performed with respect to the memory array 204. The supplemental defect management information can include information pertaining to the media access operation performed with respect to the memory array 204. For example, as described herein above, the supplemental defect management information can include information related to a program operation, an erase operation, or a read operation that is performed with respect to the memory array 204.

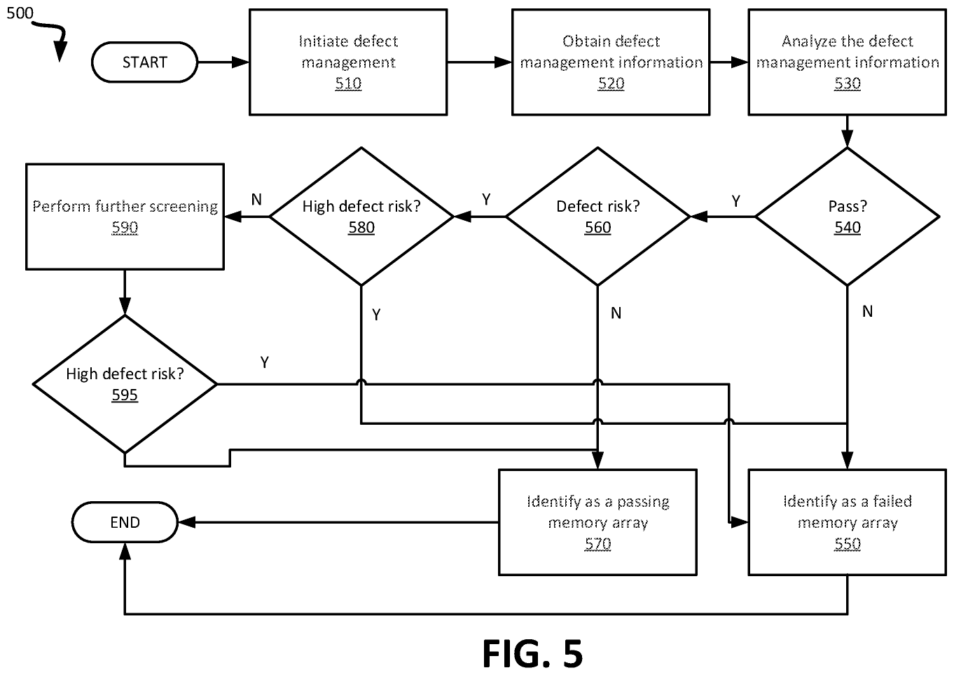

The DM component 113 can then issue a defect management information command to the memory device 130 to obtain the defect management information. For example, the defect management information command can be a “get feature” command (e.g., EEh command) or other suitable command. The DM component 113 can receive the defect management information, and analyze the combination of the status information and the supplemental defect management information to determine a likelihood of defect with respect to the memory array 204. For example, the DM component 113 can determine whether the memory array 204 should be treated as being a defective or bad memory array (e.g., defective or bad block). For example, if the status information indicates “pass” and the analysis of the supplemental defect management information indicates that there is no risk that the memory array 204 is defective, then the memory sub-system controller can identify the memory array 204 as passing and no further screen need to be performed. If the status information indicates pass, but the analysis of the supplemental defect management information indicates a low risk that the memory array 204 is defective, then the memory sub-system can designate the memory array 204 for further screening (e.g., for stress, short and/or leakage detection). If the status information indicates “fail,” or the status information indicates “pass” and the analysis of the defect information indicates a high risk that the memory array 204 is defective, then the DM component 113 can cause the data of the memory array 204 to be migrated to another block, and the DM component 113 can identify the memory array 204 as being a defective or bad memory array 204. Accordingly, by offloading defect management to the memory sub-system controller 115, instead of performing the defect management locally on the memory device 130, memory device performance can be improved, and memory device die size need not increase. Further details regarding the operations performed by the local media controller 135 to perform defect management will be described below with reference to FIG. 4, and further details regarding the operations performed by the memory sub-system controller 115 to perform defect management will be described below with reference to FIG. 5.

FIG. 4 is a flow diagram of an example method 400 performed by a local media controller to perform defect management, in accordance with some embodiments of the present disclosure. The method 400 can be performed by control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the local media controller 135 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, defect management information is stored. For example, control logic (e.g., local media controller 135) can cause the defect management information to be stored. The defect management information can include status information with respect to a memory array of the memory device stored in a status register (e.g., 1-bit pass/fail status information) of the memory device, and supplemental defect management information stored in a supplemental defect management information store (e.g., SRAM) of the memory device. The supplemental defect management information can be obtained during a media access operation performed with respect to the memory array. For example, the supplemental defect management information can include information related to a program operation, an erase operation or a read operation. Further details regarding storing the supplemental defect management information are described above with reference to FIG. 3.

At operation 420, a defect management command is received. For example, control logic can receive the defect management command from a memory sub-system controller (e.g., the memory sub-system controller 115). For example, the command can be a “get feature” command (e.g., EEh command) or other suitable command. Further details regarding receiving the defect management command are described above with reference to FIG. 3.

At operation 430, the defect management information is provided. For example, in response to receiving the defect management command, control logic can provide the defect management information to the memory sub-system controller. The memory sub-system controller can then analyze the defect management information, including the status information and the supplemental defect management information, to make a decision regarding a defect status of the memory array. Further details regarding providing the defect management information are described above with reference to FIG. 3.

FIG. 5 is a flow diagram of an example method 500 performed by a memory sub-system controller to perform defect management, in accordance with some embodiments of the present disclosure. The method 500 can be performed by control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the DM component 113 of the memory sub-system controller 115 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, defect management is initiated. For example, control logic (e.g., DM component 113 implemented by the memory sub-system controller 115) can initiate defect management with respect to a memory array of a memory device. Initiating defect management can include issuing a defect management enablement command to a local media controller of the memory device (e.g., the local media controller 135) to enable defect management. The defect management enablement command issued at operation 510 can be a “set feature” command (e.g., EFh command). Further details regarding initiating defect management are described above with reference to FIGS. 3 and 4.

At operation 520, defect management information is obtained. For example, control logic can cause the defect management information to be obtained from the memory device. Obtaining the defect management information can include issuing a defect management information command to the memory device to obtain the defect management information. For example, the defect management information command can be a “get feature” command (e.g., EEh command) or other suitable command. The defect management information can include status information with respect to the memory array stored in a status register of the memory device (e.g., 1-bit pass/fail status information), and supplemental defect management information stored in a supplemental defect management information store (e.g., SRAM) of the memory device. The supplemental defect management information can correspond to a media access operation performed with respect to the memory array. For example, the supplemental defect management information can include information related to a program operation, an erase operation or a read operation. Further details regarding storing the supplemental defect management information are described above with reference to FIGS. 3 and 4.

At operation 530, the defect management information is analyzed. For example, control logic can analyze the defect management information to determine a likelihood of defect with respect to the memory array.

For example, at operation 540, it is determined whether the status information indicates that the memory array is a passing memory array. More specifically, control logic can analyze the status information to identify whether the status information indicates a passing memory array or a failed memory array. If the status information indicates a failed memory array, no further analysis needs to be performed to identify the memory array as a failed memory array. Therefore, control logic at operation 550 identifies the memory array as a failed memory array and the process ends. Identifying the memory array as a failed memory array can include at least one of: transferring data from the failed memory array (e.g., migrating data to another memory array that is not a failed memory array), marking the memory array as a failed memory array, or disabling the failed memory array.

If the status information indicates that the memory array is a passing array, there is no guarantee that the memory array does not have a defect. For example, the memory array can have a latent defect that was missed or overlooked during a media access operation (e.g., program operation, erase operation, read operation). To address this, at operation 560, it is determined whether the memory array has a defect risk. For example, control logic can analyze the supplemental defect management information to identify a defect risk level of the memory array.

If there is no defect risk (e.g., a substantially low defect risk), control logic can identify the memory array as a passing memory array at operation 570, and the process ends. If there is a defect risk, then control logic can determine whether the defect risk is a high defect risk at operation 580. If the defect risk is determined to be a high defect risk, then the memory array is identified as a failed memory array at operation 550.

The level of defect risk (e.g., low, medium or high) can be defined based on volume testing and data qualification. For example, during high volume manufacturer, at least some memory device parts can be regularly sampled during high volume quality and/or reliability testing. During these tests, failure can be correlated with early signals. The level of risk can be determined by a probability that a defect will occur based on the result of the high volume quality and/or reliability testing. The level of risk determination can be dependent on, for example, layer of memory, number of tiers, etc.

For example, assume that a memory array fails at the 1000^{th} programming cycle due to a WL to pillar short defect. However, the memory array showed an elevated current leak start from the 900^{th} programming cycle. The elevated current leak can be an early indication or signal of the failure that resulted at the 1000^{th} programming cycle. Accordingly, the elevated current leak in this example is a high risk signal indicating a high defect risk.

If there is a defect risk, but not a high defect risk, this means that additional testing may be needed to determine whether the memory array should be treated as a passing memory array or a failed memory array. The assumption is that a good component will not change much with the stress added as a result of the test, but a defective component will be degraded by the added stress. At operation 590, further screening is performed. For example, control logic can initiate one or more tests to determine whether the memory array is defective. Examples of test include stress tests, current leakage tests and/or short tests. For example, tests can be performed by measuring current differentials between components of the memory array during media access operations (e.g., current differential between wordlines, between a wordline and a pillar).

It is then determined, based on the further screening, whether there is a high defect risk at operation 595. If not, then it is deemed safe to continue using the memory array and the memory array is identified as a passing memory at operation 570. If the further screening determines that the memory array has a high defect risk, then the memory array is identified as a failed memory array at operation 550.

As another example, an elevated current leak may not necessarily mean that the memory array will fail (e.g., some memory arrays can continue to function even with the elevated current leak). In this case, the elevated current leak can correspond to a medium defect risk.

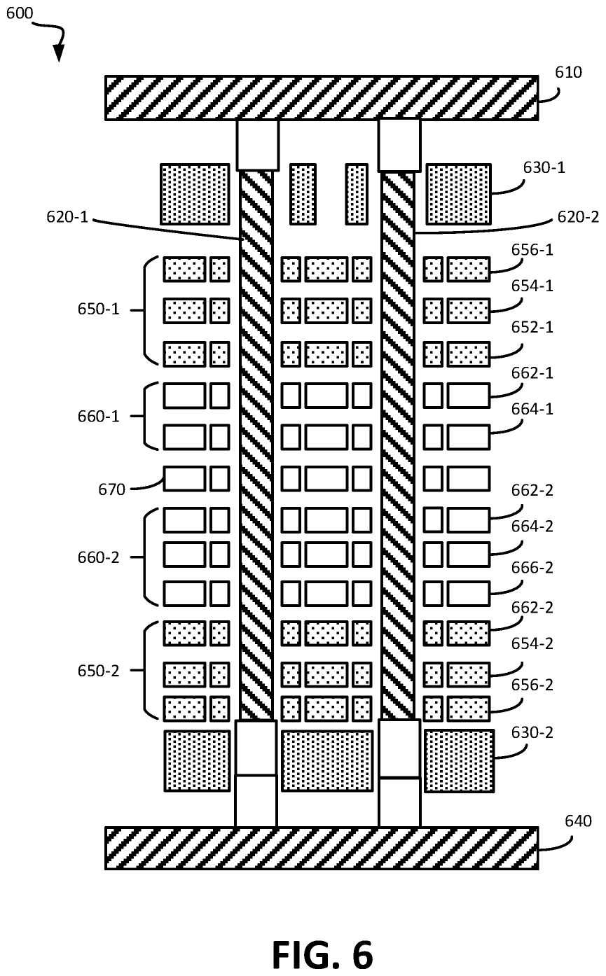

FIG. 6 is a diagram of an example memory device (“device”) 600 including a memory array, in accordance with some embodiments of the present disclosure. For example, the device 600 can be a three-dimensional (3D) replacement gate memory device including a memory array having one or more decks or tiers. However, such an example should not be considered limiting.

As shown, the device 600 includes a bitline 610, pillars 620-1 and 620-2, select gates (SGs) 630-1 and 630-2, a source line (SRC) 640, and wordline (WL) groups 650-1, 650-2, 660-1 and 660-2. More specifically, WL groups 650-1 and 650-2 are dummy WL groups, and WL groups 660-1 and 660-2 are active WL groups. WL group 650-1 includes dummy WLs 652-1 through 566-1, WL group 650-2 includes dummy WLs 652-2 through 656-2, WL group 660-1 includes active WLs 662-1 and 664-1, and WL group 660-2 includes active WLs 662-2, 664-2 and 666-2. However, such an example should not be considered limiting. A dummy WL corresponds to memory cells that do not store data and are included to satisfy processing margins, while an active WL corresponds to memory cells that store data.

As further shown, a WL 670 is provided. In some embodiments, the device 600 is a multiple deck device, in which WL groups 650-1 and 660-1 are associated with a first deck (e.g., an upper deck) of the device 600 and the WL groups 650-2 and 660-2 are associated with a second deck (e.g., a lower deck) of the device 600, such that the WL 670 corresponds to a dummy WL separating the WL groups 660-1 and 660-2. In other embodiments, the device 600 is a “single deck” device, in which the WL groups 660-1 and 660-2 are not arranged in decks. Here, the WL 670 can be an active WL within one of the WL groups 660-1 or 660-2.

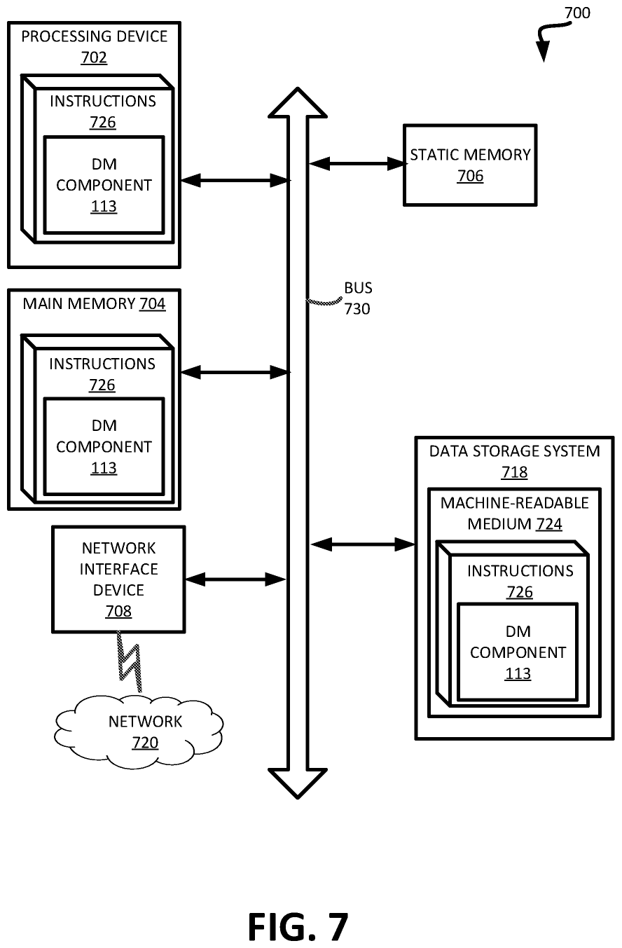

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the DM component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a DM component (e.g., the DM component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a memory array; and
a processing device, operatively coupled with the memory device, to perform operations comprising:
causing defect management information to be obtained from the memory device, wherein the defect management information comprises status information with respect to a status of the memory array and supplemental defect management information associated with a media access operation performed with respect to the memory array;
analyzing the defect management information to determine a likelihood of defect with respect to the memory array; and
identifying, based on the likelihood of defect, a defect status of the memory array.

2. The system of claim 1, wherein the status information is obtained from a status register of the memory device, and wherein the supplemental defect management information is obtained from a volatile memory of the memory device.

3. The system of claim 1, wherein analyzing the defect management information comprises determining whether the status information indicates that the memory array is a passing memory array.

4. The system of claim 3, wherein identifying the defect status of the memory array further comprises:
in response to the status information indicating that the memory array is a failed memory array, identifying the defect status of the memory array as a failed memory array.

5. The system of claim 4, wherein identifying the defect status of the memory array as a failed memory array further comprises at least one of: transferring data from the failed memory array, marking the memory array as a failed memory array, or disabling the failed memory array.

6. The system of claim 3, wherein analyzing the defect management information further comprises:
in response to the status information indicating that the memory array is a passing memory array, determining whether the memory array has a defect risk based on the supplemental defect management information.

7. The system of claim 6, wherein identifying the defect status of the memory array further comprises:
in response to determining that the memory does not have a defect risk based on the supplemental defect management information, identifying the defect status of the memory array as a passing memory array.

8. The system of claim 6, wherein analyzing the defect management information further comprises:
in response to determining that the memory has a defect based on the supplemental defect management information, determining whether the memory array has a high defect risk based on the supplemental defect management information; and
in response to determining that the memory does not have a high defect risk based on the supplemental defect management information, causing further screening to be performed with respect to the memory array to determine whether to identify the memory array as a passing memory array.

9. The system of claim 8, wherein identifying the defect status of the memory array further comprises:
in response to determining that the memory has a high defect risk based on the supplemental defect management information, identifying the defect status of the memory array as a failed memory array.

10. The system of claim 1, wherein the supplemental defect management information store comprises a volatile memory device.

11. A method comprising:
causing, by the processing device, defect management information to be obtained from the memory device, wherein the defect management information comprises status information with respect to a status of the memory array and supplemental defect management information associated with a media access operation performed with respect to the memory array;
analyzing, by the processing device, the defect management information to determine a likelihood of defect with respect to the memory array; and
identifying, by the processing device based on the likelihood of defect, a defect status of the memory array.

12. The method of claim 11, wherein the status information is obtained from a status register of the memory device, and wherein the supplemental defect management information is obtained from a volatile memory of the memory device.

13. The method of claim 11, wherein analyzing the defect management information comprises determining whether the status information indicates that the memory array is a passing memory array.

14. The method of claim 13, wherein identifying the defect status of the memory array further comprises:
in response to the status information indicating that the memory array is a failed memory array, identifying the defect status of the memory array as a failed memory array.

15. The method of claim 14, wherein identifying the defect status of the memory array as a failed memory array further comprises at least one of: transferring data from the failed memory array, marking the memory array as a failed memory array, or disabling the failed memory array.

16. The method of claim 13, wherein analyzing the defect management information further comprises:
in response to the status information indicating that the memory array is a passing memory array, determining whether the memory array has a defect risk based on the supplemental defect management information.

17. The method of claim 16, wherein identifying the defect status of the memory array further comprises:
in response to determining that the memory does not have a defect risk based on the supplemental defect management information, identifying the defect status of the memory array as a passing memory array.

18. The method of claim 16, wherein analyzing the defect management information further comprises:
in response to determining that the memory has a defect based on the supplemental defect management information, determining whether the memory array has a high defect risk based on the supplemental defect management information; and
in response to determining that the memory does not have a high defect risk based on the supplemental defect management information, causing further screening to be performed with respect to the memory array to determine whether to identify the memory array as a passing memory array.

19. The method of claim 18, wherein identifying the defect status of the memory array further comprises:
in response to determining that the memory has a high defect risk based on the supplemental defect management information, identifying the defect status of the memory array as a failed memory array.

20. A memory device comprising:
a memory array;
a status register;
a supplemental defect management information store; and
control logic, operatively coupled with the memory array, the status register, and the supplemental defect management information store, to perform operations comprising:
storing defect management information associated with a media access operation performed with respect to the memory array, including storing status information in the status register and storing supplemental defect management information in the supplemental defect management information store;
receiving a defect management command from a memory sub-system controller communicably coupled to the memory device; and
in response to receiving the defect management command, providing the defect management information to the memory sub-system controller.
